(19) United States
(12) Patent Application Publication
(10) Pub. No.: US 2010/0023405 A1
(43) Pub. Date: Jan. 28, 2010

(54) ADVERTISING BY TAGGING PREDEFINED KEYWORDS OR PHRASES ONTO CONTENT OR MEDIA

(76) Inventor: Edward Liu, Taipei (TW)

Correspondence Address: Edward Liu, 5F-1, Sec. 1, AnHo Road, Taipei, TW

(21) Appl. No.: 12/177,896

(22) Filed: Jul. 23, 2008

(51) Int. Cl. G06Q 30/00

(52) U.S. Cl. 705/14.66

(57) ABSTRACT

This invention introduces an advertising method that enables content or media (including but not limited to all contents or media on the internet, pictures, videos, radio, television, newspaper, magazines, and other forms of mediums that are capable of being related to products and services) to be tagged with predefined keywords or phrases (also including but not limited to videos, audios, pictures, and other methods of identifying content) advertisements, affiliate marketing advertisements, or additional information. Said predefined keyword tags are stored in a database and are associated directly to predefined advertisements (including but not limited to manufacturers, companies, product selling/distributing agencies, and any other form of stores or shops), affiliate marketing advertisements, or additional information. Said predefined keyword tags are inserted manually by users (individuals, agencies, organizations, or companies) in order to relate to said content or media and to specify which corresponding advertisements to deliver. The displayed advertisements will be shown as forms including but not limited to: lists of products/services, blended content, widgets with affiliated products/services, etc. There is also no limit as to where said tags and said advertisements can be sent to. Most importantly, this invention allows media to be tagged with related products or services so that the product manufacturer/distributor, the advertising, and the individual (media creator) all benefit from it.

### BACKGROUND OF THE INVENTION

1. Field of the Invention

The present invention relates generally to a new method and apparatus that enables media (including but not limited to Internet web pages, photos, blogs, videos, television, billboards, newspaper, emails, and other forms of mediums that are able to be related to products and services) to be tagged with predefined keywords and phrases retrieved from databases in able to display advertisements, affiliate marketing, and/or additional related information to the content of the media. This invention not only introduces new ways to advertise, but also allows content and media to be tagged with interesting and relevant information that can be monetized.

The internet has become one of the most powerful sources for information. Most importantly, the infrastructure of enabling everybody to be able to provide information has never been more complete. There are websites such as Wikipedia, Facebook, Myspace, Youtube, and other major websites that all have reached their prominence in the internet world via having the majority of their content created by their users. This is called Web 2.0, and there is no other way to create content faster than to have everybody collaborate. This more than creates rich content for the website companies, but it also creates endless opportunities for users to contribute and become entities of their own. However, even though the internet and its major players have found ways to collect content richer and more complete than other mediums in any given time in the past, some have also hit stubborn obstacles. Such obstacles are problems like monetizing their content.

Companies like Google's Youtube and Facebook have spent enormous effort in trying to create ways to monetize their content without irritating their users. Youtube is the world's biggest player in user-generated video website. Its success has threatened the ratings of TV and revenue from TV advertising. However, even though reducing the revenue of television companies, Youtube has not been able to monetize their valuable content. Youtube has tried to place “relevant” advertisements beside the videos and have recently attempted to integrate advertisements into the videos so that their audience would have to wait through the advertisement before they can watch what they intend to watch. More so, the original intent of the users on Youtube is not to see advertisements but are to watch videos. Facebook on the other hand has faced similar difficulties.

Facebook is the most popular social network service that initially only allowed users from colleges and universities to sign up. Its entertainment comes from the feature that allows users to add each other as friends. This college pride theme quickly made Facebook the most popular social network with many entertaining features such as uploading photos/videos, writing blogs, playing games, creating groups, chatting, etc. However, just like Youtube, they have collected excellent content but have not been able to monetize it. Therefore, they created an advertising program called the “Beacon,” which tailors advertisements according to the “private” information that they collect from their users. However, this intrudes the privacy of its users and it also makes users who are only on the website to chat with their friends see irrelevant advertisements or affiliate marketing asking them to make purchases.

What makes this invention possible is the introduction of a feature called “Tagging” on the internet. Tagging is a feature on the Internet that enables users to “tag” their content or media with related keywords so that their content or media can be discovered more easily. More importantly, tagged keywords summarize the content or media and let the audience know what is and what's in the content or media. Furthermore, Tagging has also been extended to include advanced features such as tagging individuals or items in photos or videos where specific areas or timestamps in the picture or video can be tagged with keywords. These tagged areas are recognizable by users through boxes or visible enclosures that mark the tagged area. However most websites or services have not yet utilized this “Tagging” feature by combining it with methods of advertising and affiliate marketing.

It is obvious that there is a lot of extremely valuable content on the internet but very few ways to monetize and make better use of them. Therefore, it is mandatory to invent a new way to provide extremely relevant and wanted advertisements and information without irritating the users. There also needs to be ways where content-creating entities are able make themselves profitable by tagging their content or media with related advertisements, affiliate marketing advertisements, and additional information. These two ways combined creates a method and apparatus where content or media can be tagged with related advertisements, affiliate marketing advertisements, and information that are not irritating to the audience due to the relevance of the advertisements and information with the content or media.

2. Description of the Related Art

The general purpose of the present invention, which will be described subsequently in greater detail, is to provide new ways of providing extremely relevant and entertaining advertisements as well as useful information to users whom are browsing or watching a content or media. Even though the main purpose of this invention focuses on the result of a new way of advertising, it also has unlimited advantages and possibilities. This invention introduces many novel features that result in new ways of using the extracted and delivered information and data which are not anticipated, rendered obvious, suggested, or even implied by any of the prior art, either alone or in any combination thereof.

Compared to all of the other industries in the world, the advertising industry is probably one that requires the most strategic planning. Most media services such as television, the Internet, radio, newspaper, magazines, etc. all have their own ways to advertise to their audience. It is also easy to say that there have been countless ways of advertising that have been introduced throughout the long history of advertising. The internet uses several advertising strategies, such as contextual advertising, behavioral targeting, affiliate marketing, etc. The television industry uses audience targeting, where the demography, location, and time are the most important profiles. Radio uses a similar advertising approach to that of the television industry. Many advertising methods are used, but the present invention is a new method and apparatus that's never been realized before.

Furthermore, the invention introduces a new advertising method, using another existing technology called “Tags.” However, a hybrid of advertising and tagging was never realized. The tagging function is nowadays widely used by many websites on the internet. These websites include websites like Facebook, Youtube, Myspace, Flickr, and other popular websites. Tags were initially used in programming as HTML meta tags so that search engines can more easily identify the nature of websites by crawling the websites' codes. However, as tags evolved, they slowly became useful on a higher level. Websites started to allow their users identify their uploaded content or media via “Tags” that basically summarizes the nature of the content and allow other users to easily find content via inputting tag keywords. Tags have become an essential ingredient in most successful websites. However, there is not yet any advertising platform that is built around the tagging system, and there is a big opportunity to do so. This is because tagging is naturally something that helps users identify things, and the present invention's method help those tags by providing more relevant information in form of advertisements or information about the content or media that the user is viewing.

It can be appreciated that services using different methods of advertising and tagging systems have been in use for years. However, there needs to be a solution in which tags are better utilized and explored. In these respects, the usage of tagging content or media to provide advertisements and additional information according to the present invention substantially departs from the conventional concepts and designs of prior arts, and in doing so provides an apparatus and method developed for the monumental enhancement of advertising and information technology via tagging content and media.

### SUMMARY OF THE INVENTION

This and other objects of the present invention are accomplished by using the present “Tagging” technology that is used widely on internet websites in junction with an advertising network that provides advertisements to the content or media that the user is tagging. The said content or media that can be tagged includes a wide variety of mediums that can be forms of objects, computer, billboards, radio show, audio/video programs, pictures, videos, or displays that are capable of having recognizable items within. There is no limit to how many ways the resulting advertisements or information from the tagging can be displayed, however the predicted medium of choice would most likely be the internet's web pages. This is due to the fact that the Internet is more readily tangible for tagging its content. However, as there are many programs on television nowadays where the primary mission is to sell products (shopping channel), the television is also a great medium for tagging. If televisions can be set up to adopt this invention, users can tag the products and services within a television programming and display the advertisements and information at the bottom of the display, then this basically makes every television programming a shopping channel without irritating the audience while providing wanted information that can be monetized.

Tagging the content or media using the present invention can result in displaying including but not limited to: a list of products that can be purchased, a banner advertisement, a small window of additional information related to the tagged item in the content or media, a discount advertisement for a certain product or service present in the content or media, and other forms of providing advertisements and information. The present invention provides a new method and apparatus of displaying advertisements and useful information, but what it really enables is even more novel. This invention enables every user or entity to tag items in content or media using said invention, and to be able to monetize them. This invention also helps many major websites that are unable to efficiently and subtly provide advertisements to their users. Implementing this invention into their website can allow all of their users or entities to share some revenue by tagging their own content or other users or entities content. This is a win-win situation where the website benefits, the user or entity benefits, and the advertising network benefits as well. More so, this infrastructure incentivizes user or entities to provide better content at a better efficiency. This also helps the website, the user/entity, and the advertising network.

In details, this invention enables a scenario—i.g. a user is tagging sections of the content or media (i.g. a photo or a video), and is given choices of typing in items or selecting predefined selections that is provided by the website. Besides just the choices given to the user by the website (i.g. names of people, groups of people, etc.), this invention's said database provides the user with other selections (i.g. products, services, brands, advertising campaigns), which can be displayed along with the tags provided by said website. If the predefined keywords from said database are tagged, then section(s) of corresponding (to the tagged keywords) advertisements or information are displayed on the page with the tagged content or media. The sections can be shown as lists of products for sale, advertisements, or additional information that may or may not be monetized.

In this respect, before explaining any embodiments of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

In the market for advertisements, an embodiment of the present invention provides a method and apparatus for television programs to gain new ways to advertise efficiently to their audience. The television program broadcasters can adopt this invention so that they can tag the sections and scenes (along with the time aspect) of their TV programs with products or services that appear in the program. Watchers who are interested can then follow the instruction from the tags on a small section on the TV to learn more about the products and services if they want to purchase them. Another variation of this previous embodiment enables the program broadcasters to allow their audience to also participate and to tag the sections and scenes in the TV programs. These methods also allow these TV programs to be better understood by the audience if in case the audience is unable to find out more information about the products or services presented in a TV program. Furthermore, they are recaps of important content for the TV programs.

In aspect of an apparatus of this present invention, the well known TiVo is a perfect example of how users can use this invention. TiVo is used by users to record videos when they are not able to watch the TV program at the airing time. There are a few scenarios for example where we can consider possibilities of using this invention.
Scenario 1: The tags that the user contributes during a TV program's normal airing can be uploaded via an interconnected infrastructure to the TiVo so that the TiVo's owner can benefit from a real time presentation of tags during their viewing.
Scenario 2: The TiVo's owner is watching a recorded show on the TiVo and uses an integrated interface using this invention's method to tag timestamps and sections in the TV program. The tags are later on uploaded to the remote database of the TV company that airs the particular TV show, so that the tags can appear in future reruns of said TV show.

In another embodiment of the present invention provides a method and apparatus for radio programs to be used with the present invention as well. This invention can be utilized such that the content in a radio program can be tagged by the radio broadcasting company or it can also be tagged by the audience listening to the radio program. This makes it easier for people to recap on what were the important points or interesting content in a radio program. This also makes it easier to find out about information that they wanted to find out. With all the audience contributing to tag interesting content of a radio program, the information database for a radio program can become a lot more complete and visual. Besides making the information transparent to everybody, this also creates monetizing opportunities.

There has thus been outlined, rather broadly, the more important features and embodiments of the invention in order that the detailed description thereof may be better understood, and in order that the present contribution to the art may be better appreciated. There are additional features of the invention that will be described hereinafter.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

The invention is illustrated by way of example and not limited to the figures attached. Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram of the general representation of this invention;

FIG. 2 is a block diagram of the general representation of an apparatus of this invention;

### DETAILED DESCRIPTION OF THE INVENTION

Turning now descriptively to the drawings, in which similar reference characters denote similar elements throughout the several views, the attached figures illustrate general representations of using this invention to display relevant advertisements and information according to the specific content tagged by entities or users. The advertisements, affiliate marketing, and information resulted from tagging of the content or media not only creates monetizing opportunities but also makes the content or media more complete and therefore interesting in that a lot of the information that is sought after in the content or media is made transparent by entities and users using the methods of this invention.

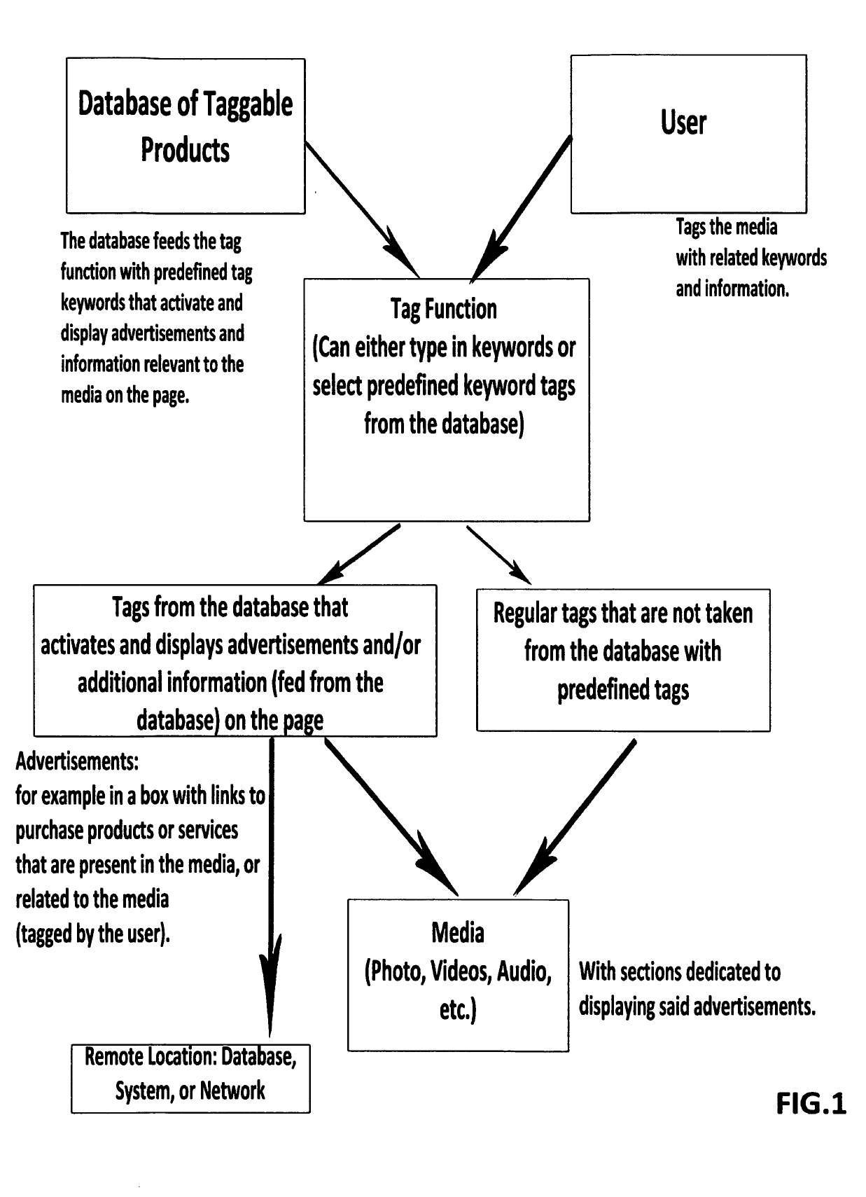

As an example, we will use the previously mentioned Facebook as an example. Facebook's infrastructure is perfect for using this invention, for reasons such that people upload a lot of photos on the website, and their audience are people who really want to find out what their friends are doing on Facebook. More so, the people will want to find out what their friends are doing and using. Therefore, please look at FIG. 1, which is a simple representation of an example like Facebook using this invention:
1. User 1 uploads a photo onto Facebook.
2. User 1 wants to tag the photo with what's present in the photo, which is a photo that consists of User 1 and her friends.
3. After clicking on the “Tag” button on the page, User 1 then clicks on a specific area on the photo to tag (i.g. bag, shoes, make up, etc.).
4. The “Tag” function in Facebook then presents tagging selections in a vertical list such as User 1's friends, or just typing in a phrase.
5. User 1 is trying to tag her bag in the picture, so that she types in the phrase, “Miu Miu Bow Satchel Coffee Edition Bag.” The bag is tagged with “Miu Miu Bow Satchel Coffee Edition Bag: Model: JR-0000XYZ.”
6. The Advertising/Affiliate Marketing Network Database has the “Miu Miu Bow Satchel Coffee Edition Bag” in its database, so it sends the information that it has in the database on that particular item.
7. The data is sent to the same page that the photo is on, and is displayed as a box with additional information like said bag's picture, price, dimensions, and production date. At the bottom the of the picture and description shows the vendors in a list that carry that item.
8. User 2 comes to look at User 1's picture and finds the item to be interesting, so User 2 clicks on one of the vendor's link in the rendered section to check out more information item.
9. User 2 finds it interesting enough and decides to purchase the item.
10. User 1 is paid a commission for linking the items on his page and having them result in a sale.
11. (Optional)—The item bought by User 2 is recorded into the database, so that a related complimenting application can take record and show what products or services User 2 owns. This data can be used for additional advertising purposes (so that advertising agencies know what User 2 likes to buy), or for entertaining purposes (so that an application can allow users to share with each other what products they have).

As another example, we can use a television soap opera as the medium for using this invention. Take the show “Sex and the City” for example. This invention is perfect for TV programs because it is capable of showing relevant information that can be monetized. This invention makes it a real time shopping channel that more than advertises for products and services, but also provides interesting information for watchers that are interested in learning more about the TV show. Please look at FIG. 1, which is a simple representation of an example using this invention on “Sex and the City.”
1. The show's scene is a few women talking at a coffee shop and each have distinct outfits and accessories along with different cell phone services.
2. The users (including but not limited to individuals, organizations, businesses, etc) recognizes the products and services and then goes on the Internet and reach the TV show company's website that is set up to allow users to use the present invention to tag products and services.
3. The users tag the products in the TV show, such as the names of the dresses or shoes the female characters are wearing. The typed in names of the products are detected from the advertising network's database of predefined keywords and phrases, so that the database returns the correct full names of the products if the user typed in incorrectly. Pictures are shown in junction with the keywords or phrases just to help with identifying the products and services used in the TV show.
4. After the products and services are tagged, the database returns the corresponding advertisements or affiliate marketing advertisements according to the tagged keywords and phrases.
5. At the bottom of the TV screen shows a running line indicating the products and services tagged in the scene, and also showing their timestamps. For example, “Miu Miu Bow Satchel Coffee Bag: 15:34 PM: Dial 800-888-8888; Code: 345678. Visit http://www.sexinthecitytags.com for more information.”
6. So the user can either make the call to find out more information about buying the products or he/she can go to the website indicated and find out more information via the Internet.
7. Scenario 1: The user makes the call and is given choices of different vendors to buy the product from. Information on the product, prices, and logistics is provided.
   Scenario 2: The user goes on the internet and finds the product he/she is looking for. The user clicks on the product and then finds more information on the product, such as the price, dimensions, available vendors, production date, etc. The vendors are shown as a price comparison chart where the user can decide where he/she wants to purchase the product from.
8. After the product is purchased, the advertising network makes money from advertising/affiliate marketing commission, and splits it with the TV company and also shares some of it with the user whom tagged the content.

As another example, a magazine is used as the medium for tagging.
1. The user buys a gossip magazine XYZ, and discovers items in the magazine that are not identified.
2. Said user goes onto XYZ's website (or an ad agency's website) to tag said items.
3. XYZ's website has a specific section where users can tag items.
4. The user tags the item by tagging it with its name or model name (where it is retrieved from an advertisement or informational database), specifies which page and edition the item is in, approximately where on the page the item is at, the description of the item, etc.
5. When another user is looking to see what item it is, the user can go onto XYZ's website's special tagging section to find out and possibly make a purchase.

This magazine example is one demonstrating how an intangible medium can be tagged. However, the example is on a smaller scale where each magazine has a separate website to handle the tags from users. A good way to unify all of the tagging is to have an tagged information aggregating website that has a core business model of serving advertisements. Take for instance:
1. There is a website TAGGLER that handles all of the tags for intangible mediums like magazines, newspapers, radios, television broadcasting. The website is organized so that every magazine brand, newspaper publisher, radio channel, and TV program are listed and organized in an easily discoverable way. Such that under magazines section you will find: Technology, Automobiles, Teens, Fashion, etc. And under Technology you will find even more specific categories such as: Laptops, Computers, Gadgets, Stereos, Home Theaters, etc. And under Laptops there are specific magazine publishers such as: XYZ, YXZ, XYY, Laptop World, and so forth.
2. A user is reading a fashion magazine POP, and discovers multiple items in the magazine that are unidentified and should be interesting to other magazine readers.
3. Said user goes onto website TAGGLER and navigates through →Magazines→Fashion→Women→POP→2008 June Edition.
4. Said user tags the items by keying in the page, the keywords or phrases (where the exact models, products, services, or people, will show up when detected), location on the page, description, and other information.
5. After the system acknowledges the items tagged, it will display advertisements, affiliate marketing advertisements, or additional information on the page or on another.
6. Another user goes onto
   TAGGLER→Magazines→Fashion→Women→POP→2008 June Edition to look for information. The user finds what she looks for, which are the items that said user tagged, and purchases them. TAGGLER acknowledges the sell through, and shares a part of the commission with said user.

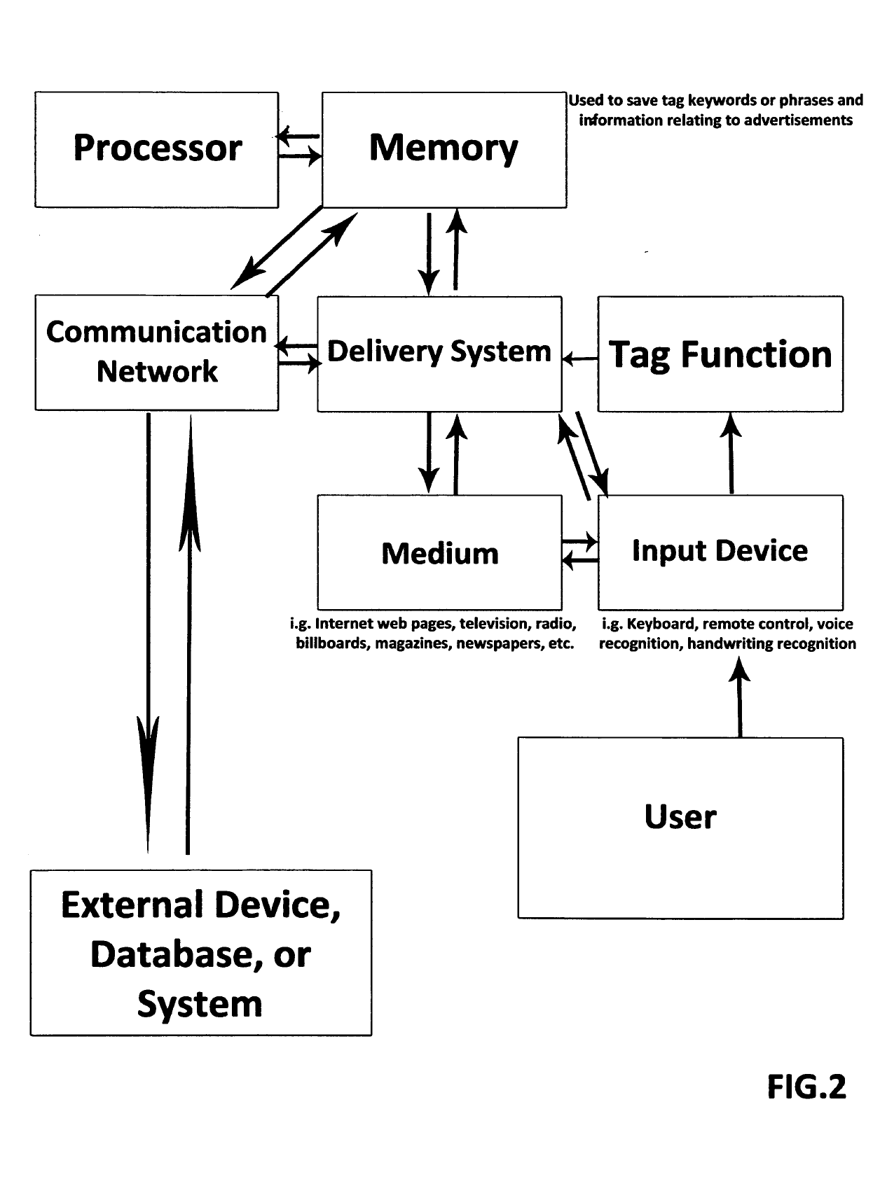

As another example to demonstrate usage of this invention as an apparatus, I will use TiVo as an example. TiVo is a hardware device where its major functionality is to record TV programs when the owner is not present to watch the normal airing. Please look at FIG. 2, which is a simple representation of this invention as an apparatus. This invention's apparatus is tied to the TiVo or integrated into the TiVo such that the communication network can send and retrieve information from the TiVo. The medium of said apparatus is shared with TiVo, which is the television.
1. The TiVo owner is unable to make it for the normal airing of the show “Sex and the City,” so she recorded the episode on TiVo.
2. The episode was originally tagged with keywords and phrases, and was associated with most of the products and services present in the episode. This information is saved into the memory of TiVo.
3. During the playback of this episode, the data assigned to this episode in the memory's database sends this information via a communication network as a list of rolling advertisements to the bottom of the TV screen (medium) so that this information is displayed in junction with the playback.
4. The user chooses some advertisements on the screen via the remote control, and finds out more information on the advertisements in a separate screen when the TV program is paused.
5. After the advertisements are successfully served to the displaying medium, a delivery system(for example an internet connection) then sends data regarding what advertisements were displayed, and what advertisements the user showed interest in, to a remote location—such as an advertising agency, or to said memory.
6. (Optional) Said TiVo owner finds other items that are untagged in the episode and she tags them. The tagged items are uploaded to the TV program company via the communication network so that other watches can see those tags next time the program is aired.

There are different levels of implementations of the present invention. The present invention allows implementation from the very basic, to more complicated structures. Therefore, it should be appreciated that many other implementations can be provided with more advanced structuring.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A method for providing advertisements (including affiliate marketing advertisements) and/or additional information by tagging (relating) keywords or phrases (also including but not limited to videos, audios, pictures, and other methods of identifying content) on a content or media (including but not limited to all contents or media on the Internet, pictures, videos, radio, television, newspaper, magazines, and other forms of mediums that are capable of being related to products and services) and then displaying or delivering advertisements, affiliate marketing advertisements, or additional information according to the tagged said keywords or phrases comprises the steps of:
Having a content or media (including but not limited to all contents or media on the Internet, pictures, videos, audios, radio, television, newspaper, magazines, and other forms of mediums that are capable of being related to products and services) created or uploaded (or already existing) by Users (including but not limited to individuals, businesses, organizations, etc.), where the content or media is capable of being related to products and services that can be tagged with related keywords or phrases.
The Tag function provides an interface where it enables said content or media to be tagged (and also display) with keywords or phrases. The Tag function allows users to tag specific areas or sections of the content or media (i.g. a segment of a photo, a certain time in a video). Additionally, the Tag function is connected to a database (locally or remotely) of predefined keywords and phrases (also including but not limited to videos, audios, pictures, and other methods of identifying a content) where said predefined keywords and phrases are also associated with advertisements (including affiliate marketing advertisements and catalogs of products and services) and additional information that are located at a local database or a remote database so that said advertisements and information can be delivered.
After a user (including but not limited to individuals, businesses, organizations, etc.), who may be or may not be the content/media creator, activates the Tag Function to tag said content or media, said Tag function, which is connected with said database, will display options for said user to input. Said user can select either to key in said keywords or phrases, where the Tag function would auto detect and output the according keywords or phrases if said predefined or keywords are identified, or to select from preselected options (names, products, services, items, etc.)—which includes data retrieved from the service serving/providing said content or media (i.g. separate entity from the advertising firm) and which also includes said keywords and phrases retrieved from said database. Said keywords or phrases retrieved from said database may have a special font style.
If keywords or phrases that are keyed in or selected are said keywords or phrases retrieved from said database, then said advertisements (including affiliate marketing) and additional information related to said keywords or phrases will be delivered to assigned destinations including but not limited to the same page as said content and media, remote destination, a different medium, etc. Said advertisements and affiliate marketing can appear in different ways such as in a list or as pictures and thumbnails. There is no limit to how said advertisements and affiliate marketing can appear.

2. A method accordance to claim 1 comprising the further steps of sharing revenue from advertisements and affiliate marketing with users that contributed in creating content or tagging them with related said keywords and phrases retrieved from said database.

3. A method in accordance to claim 1 comprising the further steps of having a feedback system where users who create content or media or tag content or media are reviewed and rated for their efficiency (in terms of using the methods in this invention).

4. A method in accordance to claim 1 comprising the further steps of said database receiving and recording detailed statistics (i.g. which user bought what, which user clicked on what, what time which users makes what action, click through rate, and other information regarding collecting more information for advertising and entertainment purposes) of advertisements, affiliate marketing, and information served by this invention.

5. A method in accordance to claim 4 comprising the further steps of having said detailed statistics sent to a remote location, i.g. database, system, device, network, website, etc.

6. A method in accordance to claim 4 comprising the further steps of displaying and sharing the products that a user owns and have bought via said advertisements and affiliate marketing advertisements from this invention.

7. A method in accordance to claim 6 comprising the further steps of creating a function for social networks so that users can share products that they own and have bought.

8. A method in accordance to claim 1 wherein said database of said keywords/phrases or said advertisements are located at a remote location.

9. A method in accordance to claim 1 wherein said user tags said predefined keywords or phrases that are in said content or media using another interface or medium wherein said tags and said advertisements are delivered to said interface or medium instead of said content or media (including but not limited to a website, device, database, system).

10. Apparatus for providing advertisements (including affiliate marketing advertisements) and/or additional information by tagging (relating) keywords or phrases (also including but not limited to videos, audios, pictures, and other methods of identifying content) on a content or media (including but not limited to all contents or media on the Internet, pictures, videos, radio, television, newspaper, magazines, and other forms of mediums that are capable of being related to products and services) and then displaying or delivering advertisements, affiliate marketing advertisements, or additional information according to the tagged said keywords or phrases comprising:
A computer processor.
A memory associated with said computer processor for storing a database of predefined said keywords and phrases as well as advertisements, affiliate marketing advertisements, and additional information associated with said predefined keywords and phrases. Said memory is also used to store statistical information regarding the performances of said keywords and phrases, advertisements and affiliate marketing, and other events that occur on said apparatus.
A medium to display said content or media, tagged keywords or phrases, and said advertisements and additional information.
A communication network where users (including and not limited to individuals, businesses, organizations, etc.) can communicate with the memory for means of assigning said predefined keywords or phrases, advertisements, and information, or retrieving information and data from said apparatus. Said communication network is also capable of connecting to remote databases or systems to download or upload information.
An input device, including but not limited to a keyboard, remote controller, an audio recognition system, a handwriting recognition device, etc., to enable the user to input commands into the apparatus.
A delivery system associated with said memory and said communication network that sends out the result of matched said predefined keywords and phrases with their corresponding advertisements, affiliate marketing advertisements, or information when said predefined keywords and phrases match what said user tagged on said content or media. The delivery destination includes but not limited to sending back to said medium or a destination that said advertisements are assigned to. There is also no limit to what form said tag keywords and phrases, advertisements, and affiliate marketing advertisements can appear as.

11. Apparatus accordance to claim 10 wherein the memory stores information regarding commission from a revenue sharing program that each contributing user makes from creating content or tagging them with related said keywords and phrases retrieved from said database in a database.

12. Apparatus in accordance to claim 10 wherein said memory records a feedback system in a database where users who create content or media or tag content or media are reviewed and rated for their efficiency (in terms of using the methods in this invention).

13. Apparatus in accordance to claim 10 comprising the further steps of said database receiving and recording detailed statistics (i.g. which user bought what, which user clicked on what, what time which users makes what action, click through rate, and other information regarding collecting more information for advertising and entertainment purposes) of advertisements, affiliate marketing, and information served by this invention into said memory.

14. Apparatus in accordance to claim 13 wherein said detailed statistics are sent to a remote location, i.g. database, system, device, website, network, etc via the communication network.

15. Apparatus in accordance to claim 13 comprising the further steps of displaying the products on said medium that a user owns and have bought via said advertisements and affiliate marketing advertisements from this invention.

16. Apparatus in accordance to claim 14 comprising a computer processor function for social networks so that users can share products that they own and have bought.

17. Apparatus in accordance to claim 10 wherein said database of said keywords/phrases or said advertisements are located at a remote location.

18. Apparatus in accordance to claim 10 wherein said user tags said predefined keywords or phrases that are in said content or media using another interface or medium wherein said tags and said advertisements are displayed on said interface or medium instead of said content or media (including but not limited to a website, device, database, system).
